(19) United States
(12) Patent Application Publication
(10) Pub. No.: US 2010/0092040 A1
(43) Pub. Date: Apr. 15, 2010

(54) OPTICAL COMPUTERIZED METHOD FOR THE 3D MEASUREMENT OF AN OBJECT BY FRINGE PROJECTION AND USE OF A PHASE-SHIFT METHOD, CORRESPONDING SYSTEM

(75) Inventor: Sylvain Fischer, Strasbourg (FR)

Correspondence Address: YOUNG & THOMPSON, 209 Madison Street, Suite 500, Alexandria, VA, 22314, US

(73) Assignee: PHOSYLAB, BISCHWILLER (FR)

(21) Appl. No.: 12/520,454

(22) PCT Filed: Dec. 18, 2007
(86) PCT No.: PCT/FR2007/052551

§ 371 Date: Jun. 19, 2009

(30) Foreign Application Priority Data
Dec. 19, 2006 (FR) 0655661

(51) Int. Cl. G06K 9/62

(52) U.S. Cl. 382/106

(57) ABSTRACT

An optical computerized method and system for the 3D measurement of the external surface of an object in relief by projection of fringes onto the object and use of a phase-shifting method, wherein four projection axes of the fringes onto the object are implemented, the origin of each projection axis being considered as an illumination point located substantially at each of the four vertices of a virtual tetrahedron, the object being placed substantially at the centre of the tetrahedron, and the shootings are taken from four shooting points located substantially along four shooting axes, each of the shooting axes being the median of one of the four trihedrons formed by the four triplets of projection axes, the four shooting points being located at such a distance from the object that, at each shooting point, each image includes at least one portion of each of the three surfaces of the object that can be lighted by the three illumination points of the triplet of projection axes, the median of which defines the shooting axis of the shooting point, and a set of images of each of the six surfaces that can be illuminated and defined by six couples of illumination points is acquired into the computer equipment.

The present invention relates to an optical computerized method for the 3D measurement of the entire or almost-entire external surface of an object in relief by fringe projection and use of a phase-shifting method, as well as a corresponding measurement system.

It finds applications in metrology, and can be associated with any downstream application using 3D information, such as for example the 3D visualisation and tool control.

Surface characterization and relief measurement by optical methods are performed using different techniques, among which are found triangulation, photogrammetry, Moiré technique, interferometry, holography and speckle technique. To date, photogrammetry is a widely used technique but its use is often limited because the measurement process is quite complex and relatively costly to implement.

Another technique consists in projecting light fringes onto the surfaces to be analysed. This projection principle is a contactless optical method which is commonly recognized as having a high potential for the measurement and characterization of very varied objects. Such method uses parallel or diverging light fringes projected onto the surface of an object by means of a conventional imaging system or by a coherent-light interference pattern and an image-acquisition apparatus whose axis is distinct from that of the fringe-projection system. The obtained light-fringe phase distribution of the acquired image contains information about the relief of the illuminated surface of the analysed object. This phase distribution is subjected to calculations to reconstruct the relief of the object's surface.

As part of the techniques using light fringes, the phase-shifting method (PSM) is a powerful method for reconstructing the phase distribution of a set of light fringes because of its great accuracy and fast execution. It has been implemented by means of a piezoelectric transducer which provides a shifting of the light fringes, i.e. which modulates the phase distribution thereof. Another implementation consists in modulating the wavelength of a laser diode by controlling the current thereof, the diode being located in a non-compensated interferometer to induce the phase shifting of the light fringes. Another alternative to induce such light-fringe phase shifting consists in implementing a liquid crystal mask in the fringe-projection system and illuminating it with a white light.

However, the calibration of the system which induces the phase shifting in the PSM technique is a very critical step. Phase-shifting calibration algorithms using four or five image acquisitions of the light fringes have been developed. Such algorithms are very useful to identify and compensate for the sources of measurement errors, such as non-constant phase shift, high-order harmonics contained in the light fringes and very low signal/noise ratios. Other methods of phase-shifting calibration have been developed, but they increase the calculation load and are thus much more resource and processor-time consuming.

Among the PSM techniques, the technique which uses two distinct shooting points and/or two distinct illumination points (in fact, the phase analysis can be performed with one illumination point and two shooting points, or two illumination points and one shooting point, or else two illumination points and two shooting points) may be associated with a phase-analysis algorithm, for the purpose of recovering the absolute value and not the value modulo 2π of the phase, i.e. the phase value without ambiguity. With this improvement, the PSM technique is robust and has a very few error propagation effects. Further, this automatically solves the problems associated with the light-fringe discontinuities which could deteriorate the result accuracy or even prevent a correct phase-measurement. The analysis algorithm is optimized regarding the time and memory consumption and is thus easy to execute on a personal computer, for example.

The present invention aims to improve the PSM technique. The invention is based on an system for reconstructing an object shape by light-fringe projection using the phase-shifting method—a Fringe Projection-Phase Shifting Method (FP-PSM) system—wherein a set of light fringes is generated by illumination of a mask with light, said mask being a screen having opaque-to-light areas and transparent-to-light areas, the latter being distributed according to a defined pattern, which produces the required set of light fringes by light transmission through the mask, and the set of light fringes is projected onto the surface of an object to be processed. Images of the fringed object are acquired with a camera and the acquisition process is repeated several times by moving the set of light fringes in the space and between each acquisition so that a phase shift of the light-fringe distribution exists between each acquired image of the object's illuminated surface. The acquired images are subjected to computer calculations. In particular, the phase shift of the light-fringe distribution between each image allows to recover the distributed variations of the height (the relief) of the object's illuminated surface, wherein such variations can be viewed according to the couple projection axis (axis of the light beam projected onto the object, also known as “illumination axis”) versus acquisition axis (axis of the image-acquisition camera, also known as “shooting axis”). The relief thus recovered is the partial relief of the object's illuminated surface, which comprises all the details visible according to the couple projection axis/acquisition axis.

The invention more particularly relates to the integration in the FP-PSM system of four paths for fringe-projection and four paths for image acquisition of the surface of an object illuminated by the fringes according to a particular tetrahedral geometry. For that purpose, the fringes are projected onto the object according to four incidences from at least one device for illuminating the object with fringes, associated with possible means for switching and deflecting the fringe light beam toward the object and the illumination points of which are taken into account, wherein an illumination point is a point from which appears to emerge the light allowing the direct illumination of the object's surface by fringes (each illumination point is thus located along the corresponding incidence, i.e. along the projection axis), wherein the illumination device, as a physical unit, can correspond to the illumination point or be physically offset from the illumination point and the illumination deflected toward the object, or, more generally, the illumination device can be distributed into several elements, one of which can correspond to the illumination point, as will be seen later. In all cases, the four illumination points are placed substantially at the vertices of a tetrahedron (at or near these vertices), at the centre of which the object is located. Thus, the straight lines from the illumination points through the centre of the tetrahedron define the projection/illumination axes of the system (or the above-mentioned “incidences”). Moreover, the four illumination points are sufficiently remote from the object so that each couple of illumination points illuminates the surface delimited by the contour viewed according to the pseudo-normal of said surface, wherein the pseudo-normal is the median of the two projection axes in the plan defined by these latter. As for the shooting operation, four shooting points are placed on the medians of the trihedrons formed by the triplets of projection axes, or near these medians, so that the shooting axes are defined by the straight lines from the shooting points through the centre of the tetrahedron. Moreover, the four shooting points are sufficiently remote from the object so that the field of view of each couple of shooting points includes the surface defined as above by the couple of the two adjacent projection axes common to the two shooting axes of the couple of shooting points. Thus, each surface included in the above-defined contour can be viewed from two shooting points. The four illumination points project light fringes onto the object, each according to its projection axis, but not necessarily the same set of light fringes. A set of images can be acquired of each of the six surfaces illuminated and defined by the six couples of illumination points, wherein said images allow to recover the partial reliefs (viewed according to the couples of projection and acquisition axes each defined by one projection axis and one acquisition axis) of each of the six illuminated surfaces of the object, said partial relief allow to faithfully recover, without ambiguity, almost all the relief details (the almost-complete relief) of each of the six illuminated surfaces of the object, and said almost-complete reliefs thus recovered of the six illuminated surfaces of the object allow to recover almost all the details, without ambiguity, of the entire external surface of the object.

More precisely, the invention firstly relates to an optical computerized method for the 3D measurement of the external surface of an object in relief by projection of fringes onto said object and use of a phase-shifting method, the fringes being projected onto the object by means of at least one illumination device, images of the fringed object being taken according to several shooting axes by means of at least one shooting means, said images being transmitted to a computer equipment comprising a program for the calculation of relief based on the images.

According to the invention, four projection axes (final optical paths of the fringes toward the object) of the fringes onto the object are implemented, the origin (which is real or virtual according to the structure of the illumination device(s)) of each projection axis being considered as an illumination point located substantially at each of the four vertices of a virtual tetrahedron, the object being placed substantially at the centre of said tetrahedron, and the shootings are taken from four shooting points located substantially along four shooting axes, each of the shooting axes being the median (from the centre of the tetrahedron) of one of the four trihedrons formed by the four triplets of projection axes, the four shooting points being located at such a distance from the object that, at each shooting point, each image includes at least one portion of each of the three surfaces of the object that can be lighted by the three illumination points of the triplet of projection axes, the median of which defines the shooting axis of said shooting point, a set of images of each of the six surfaces that can be illuminated and defined by six couples of illumination points is acquired into the computer equipment.

As used herein, “substantially” means that the points are located on the corresponding axis or nearby. The “external surface measurement” has to be understood as meaning the measurement of the surface onto which the fringes appear to be projected to the optical acquisition means, wherein possible transparent surface thicknesses can not be taken into account because the illumination fringes pass through them.

In various embodiments of the invention, the following means are used, either alone or in any technically possible combination:
the six lighting possibilities are repeated, with different fringe patterns each time,
the four illumination points come from at least one to four fringe-illumination devices, and said device(s) is(are) located at the illumination points and/or the illumination(s) of said means are redirected by at least one mirror and/or said means is(are) physically movable,
the four illumination points come from four independent illumination devices, said devices being located at the illumination points or the illuminations being redirected toward the object,
the illumination is redirected toward the object by at least one mirror,
the four illumination points come from three independent illumination devices,
the four illumination points come from two illumination devices,
the four illumination points come from only one illumination device,
the four illumination points come from only one illumination device, and the illumination from said means is redirected along the corresponding projection axis by a set of mirrors,
the mirror(s) is(are) active (the mirrors serve as a four-output beam switch),
the mirror(s) is(are) controlled by the computer equipment,
each illumination device is provided with a light source, a beam broadener and a liquid crystal screen controlled by the computer equipment to form therein a fringe pattern,
each illumination device is provided, in this order toward the object, with a light source, a beam broadener and a liquid crystal screen controlled by the computer equipment to form therein a fringe pattern,
analog light fringes are implemented (the transition between a clear band and a dark band is substantially continuous by grey-level shading),
four independent fixed shooting means are implemented, which are located at the shooting points,
four independent fixed shooting means are implemented, which are located outside the shooting points, mirror-type deflecting means being placed at the shooting points to deflect the images toward the corresponding shooting means,
three independent shooting means are implemented, at least one of which has a movable shooting axis,
two independent shooting means are implemented, at least one of which has a movable shooting axis,
only one shooting means is implemented, which has a movable shooting axis,
the shooting axis can be moved by physical displacement of the corresponding shooting means,
the shooting axis can be moved by being redirected by a set of mirrors,
the shooting means is of the type camera or still-camera and allows to take images which can be transmitted to the computer equipment,
for the shootings, the object is sequentially illuminated according to the four projection axes, to acquire a set of images of each of the six surfaces that can be illuminated and defined by six couples of illumination point.

The invention secondly relates to a system for the 3D measurement of the external surface of an object in relief, intended for implementing the method according to any one of the preceding claims, and characterized in that it comprises at least one device for illuminating the object with fringes and a part for image acquisition and calculation of relief, in a computer equipment comprising a program, based on said images acquired by at least one shooting means, wherein the illumination device(s) allow(s) fringes to be projected onto the object according to four projection axes (final optical paths of the fringes toward the object), the origin (which is real or virtual according to the structure of the illumination device(s)) of each projection axis being considered as an illumination point located substantially at each of the four vertices of a virtual tetrahedron, the object being placed substantially at the centre of said tetrahedron, and the shootings are taken from four shooting points located substantially along four shooting axes, each of the shooting axes being the median (from the centre of the tetrahedron) of one of the four trihedrons formed by the four triplets of projection axes, the four shooting points being located at such a distance from the object that, at each shooting point, each image includes at least one portion of each of the three surfaces of the object that can be lighted by the three illumination points of the triplet of projection axes, the median of which defines the shooting axis of said shooting point, and in that a set of images of each of the six surfaces that can be illuminated and defined by six couples of illumination points is acquired into the computer equipment.

In an alternative embodiment of the system, the illumination device comprises a light source, a beam broadener and a liquid crystal screen controlled by the computer equipment to form therein a fringe pattern,

The combination of a fast and easily transportable instrumentation with a robust software increases the implementability of the fringe projection technique and the phase-shifting method for object-relief reconstruction as far as the production sites. Therefore, it is advantageous in that it can be used in fast-object-sorting system with an quasi-null error rate in the recycling industry (for example, sorting by type and printer ink-cartridges recycling), in-line and real-time quality-control systems for the precision mechanics industry (for example, fast precision-presses) or to respond to the needs for fast quality-control systems in the assembly-line production industry (for example, control of the accuracy of mounting of the elements to be assembled in the engine compartment or the passenger compartment of a vehicle in the automotive industry).

According to the invention, the initial pattern of the light-fringe phase distribution is software-determined and can notably be modified (without any hardware modification in the preferred version) by a skilled operator or a software that determines the optimal pattern for a given processing, with a few information input by the operator, concerning the size of the object, the nature of its surface, the area to be processed on the surface, etc., or even automatically modified by a series of iterative adaptation measures. Further, the phase-shifting is controlled by the processor and induced by the mask in a very-short delay, which allows several image-acquisitions to be performed in a few milliseconds. Thus, because of the acquisition and processing speed thereof, the system of the invention may be classified in the category of “real time” systems, so that it can be implemented on production lines. Finally, such contactless system is well adapted to hostile environments (dirt, vibrations) and does not necessitate an absolute positioning of the object.

The present invention will now be described by way of a non-limitative example, with reference to the appended drawings, in which:

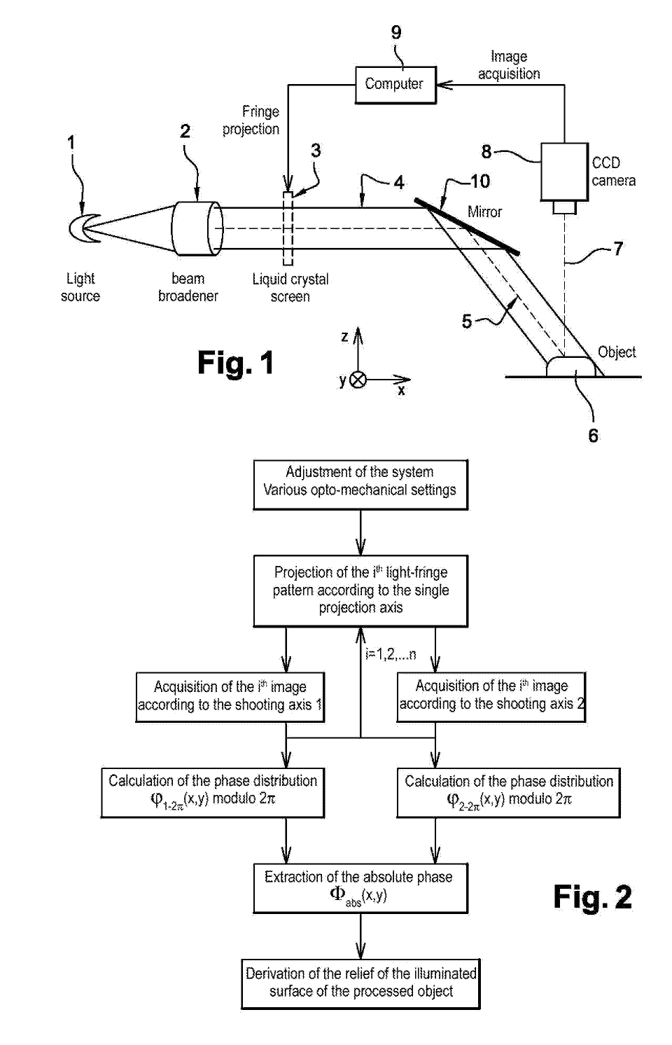

FIG. 1 is a known single-channel system for measuring the external surface of an object;

FIG. 2 is an exemplary algorithm for a two-channel system with one illumination point and two shooting points (1PI/2PV),

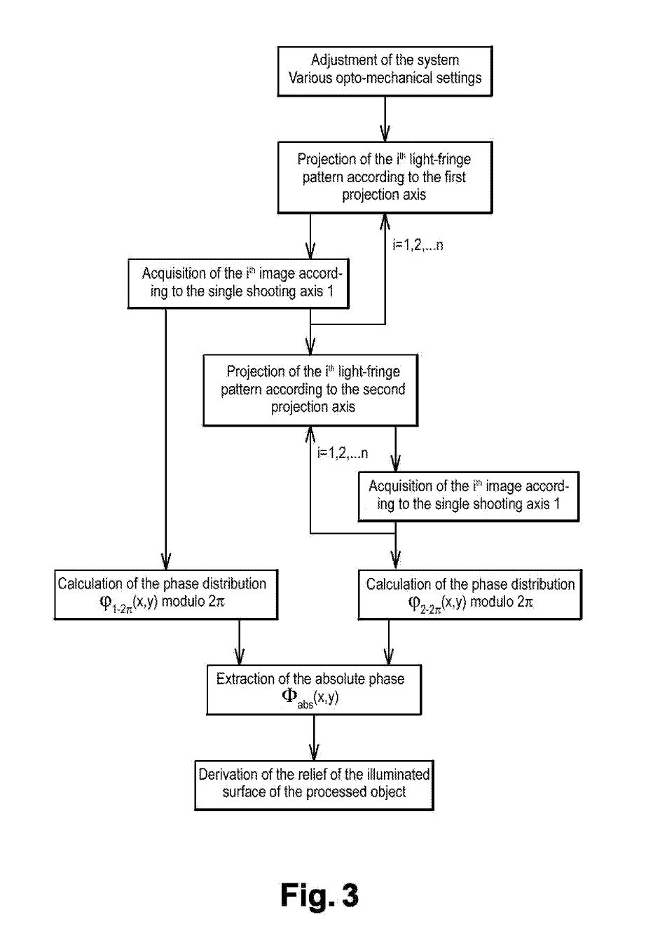

FIG. 3 is an exemplary algorithm for a two-channel system with two illumination points and one shooting point (2PI/1PV),

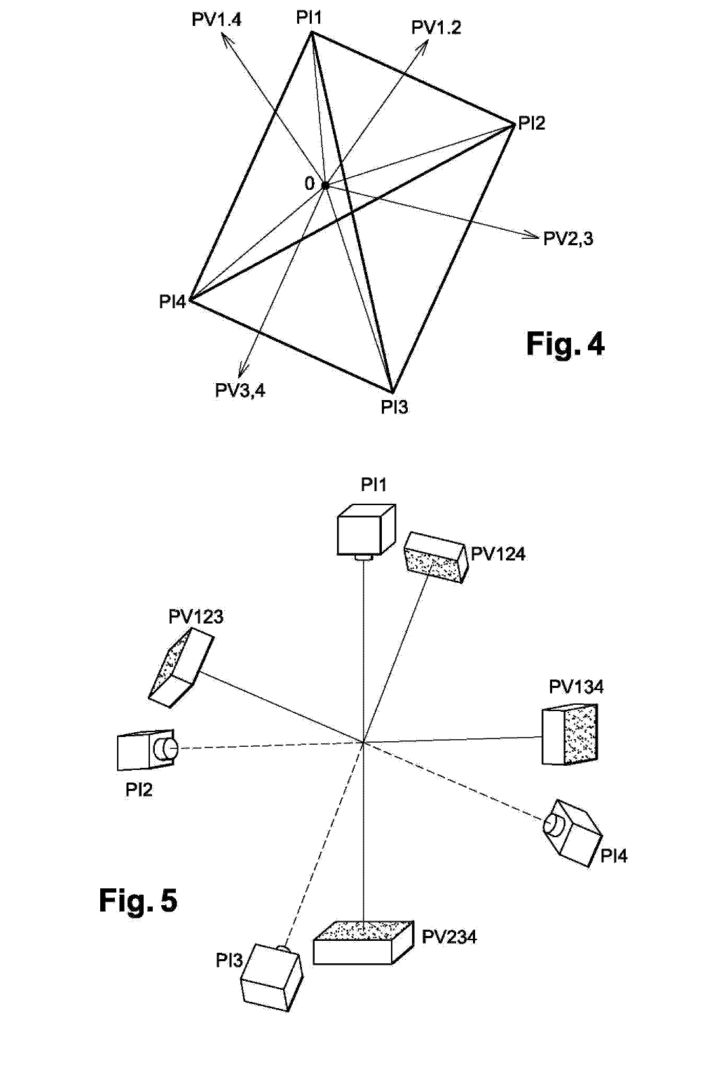

FIG. 4 schematically shows, with respect to an object, the illumination points and the projection axes for the means for fringe-illumination of the object, as well as the shooting axes on which are placed the shooting points in the case of the tetrahedral multi-channel system of the invention, and

FIG. 5 is a three-dimensional view of the tetrahedral system with, in the simplest version thereof, four liquid crystal screens placed at the four illumination points and from which emerge the light fringes projected according each projection/illumination axis, and four cameras placed at the four shooting points.

The general principle underlying the invention will now be described. A set of light fringes is generated, which is distributed within the cross-section of a light beam (the “beam”) according to a known initial pattern. The pattern being known, the fringe distribution can be modeled by a two-dimensional distribution of the light-intensity phase or of the light-fringes phase within the cross-section of the beam. Therefore, such phase distribution is described by a mathematical function φ.

The set of light fringes is projected onto the surface of an object, the relief of which is desired to be reconstructed. The set of light fringes forms on the illuminated surface of the object a deformed image of the initial pattern of the set of light fringes. Such deformation of the initial pattern is caused by the variations of the height, i.e. the relief of the illuminated surface. The image thus formed on the surface is a distribution of the light-fringe phase which results from the modulation of the light-fringe phase distribution of the initial pattern by the relief of the illuminated surface.

It is possible to deduce from several images formed on the illuminated surface of the object and, through calculations, the light-fringe phase distribution of the deformed pattern, by taking care to induce a known shift (in space) of the light-fringe phase distribution between each image formed on the surface. For this purpose, known calculation methods can be implemented. Among these methods for deriving the light-fringe distribution from several images projected with an induced phase-shift of these fringes, it can be mentioned those described in:
P. S Huang, C. Zhang and F. P. chiang, “High-speed 3-D shape measurement based on digital fringe projection”, Opt. Eng. 42(1), 163-168, 2003;
L. Salas, E. Luna, J. Salinas, V. Garçia and M. Servin, “Profilometry by fringe projection”, Opt. Eng. 42(11) 3307-3314, 2003;
I. Yamaguchi, S. Ohta, and J. Kato, “Surface contouring by phase-shifting digital holography”, Optics and Lasers in Engineering 36, 417-428, 2001; et
G. S. Spagnolo, D. Ambrosinib, D. Paolettib and G. Accardo, “Fibre optic projected fringes for monitoring marble surface status”, J. Cult. Heritage 1 S337-S343, 2000.

From this phase distribution of the deformed pattern, the relief of the object's illuminated surface can be deduced by a known calculation method. Such a method has been mentioned in, notably:
Hu and al, “Calibration of a three dimensional shape measurement system”, Opt. Eng. 42(2), pp 487-493, 2003; et
H. Zhang, F. Wu, M. J. Lalor and D. R. Burton, “Spatiotemporal phase unwrapping and its application in fringe projection fiber optic phase-shifting profilometry”, Opt. Eng. 39(7) 1958-1964, 2000.

A known single-channel system allowing a reconstruction of the partial relief of the surface illuminated by a fringe pattern is shown in FIG. 1 and comprises, for the device intended to illuminate the object 6 with fringes:
a uniform light source 1, also referred to as “source”, which is the most homogeneous possible (homogeneity of the light-power distribution within the cross-section of the emitted beam),
a beam broadener 2, also referred to as “broadener”, herein producing a parallel beam 4,
a liquid crystal screen 3, also referred to as “mask”,
possibly, a deflecting mirror 10,
the illumination device then allowing to produce an illumination beam along an illumination axis 5, and
for the acquisition and processing part:
a CCD-type camera 8 for acquiring images of the object 6 illuminated by the fringes according to a shooting axis 7,
a computer equipment 9 (computer/micro-computer) comprising a processor capable of performing algorithm-calculations on data among which are found the images acquired by the camera, and capable of controlling the mask so as to define the fringe pattern.

The light source generates the light necessary to illuminate through the mask the object's surface of which the system has to reconstruct the relief.

The beam broadener provides a parallel cross-section of the light beam with the required dimensions to correctly illuminate the mask and then the object's surface to be illuminated.

The position of the source 1 with respect to the broadener 2 determines the divergence or non-divergence of the light beam passing through the mask and lighting the object. Therefore, the dimensions of the illuminated surface are not necessarily limited to the dimensions of the mask and can be larger or smaller than these latter. However, a parallel illumination beam, as shown in FIG. 1, provides a simplification of the calculations.

If the axis of the optical system consisted of the source, the broadener and the mask, which is also the propagation axis of the light beam, is oriented so that the object's surface is directly illuminated (direct illumination), no further component is necessary between the mask and the object. If, in an alternative, this axis is initially oriented along a direction that does not pass through the object, then a mirror is placed between the mask and the object and oriented so as to redirect the initial light beam toward the object in order to correctly illuminate the surface thereof with the fringes (indirect illumination). Such double possibility of illumination explains why the notion of illumination point is introduced to qualify a virtual origin of the final beam illuminating the object with fringes, wherein the illumination point can physically correspond to the device illuminating the object with fringes if the illumination is direct or not correspond to this device if the illumination is indirect.

It is understood that this notion of direct or indirect illumination can also be applied by analogy to the acquisition part, wherein the camera can directly (the camera is located on the shooting axis 7 as shown in FIG. 1) or indirectly receive the images of the object, the images being deflected by a mirror toward a camera which is not located on the shooting axis 7. This explains by analogy why the notion of shooting point, which is located on the shooting axis, is introduced.

The processor 9 controls the mask 3 to generate the set of light fringes according to the desired pattern, controls the camera 8 and stores the images acquired by the camera and performs the required calculations for determining the relief of the object's illuminated surface, for example for a 3D visual reconstruction on a display.

This system is referred to a “single-channel system” because it comprises only one couple or duet of illumination point and shooting point.

For a reconstruction of the almost-complete relief of the surface illuminated by a fringe pattern, a two-channel system can be implemented. For example, a two-channel system comprises, on the one hand, a uniform light source that is the most homogeneous possible, a beam broadener, a liquid crystal screen (the mask), an optical beam switch and several mirrors, and on the other hand, two cameras and one processor. This type of two-channel system comprises one illumination point and two cameras, and is denoted 1PI/2PV.

The mirrors are distributed and arranged in the space so as to be capable of inflecting a light beam according either one of the two possible paths, each path being defined by a system of mirrors that permits illumination of the object's surface according to a projection axis that is peculiar to the path.

The optical beam switch is controlled by the computer and directs the light beam from the mask toward either one of the systems of mirrors. Therefore, the object's surface is sequentially illuminated according the two possible couples of projection and acquisition axes of the two-channel system.

The processor performs the reconstruction of two distinct partial reliefs and, based on these two reliefs, the reconstruction of the almost-complete relief of the object's illuminated surface. Indeed, the two partial reliefs reconstructed according to two selected ones of the four possible couples of projection and acquisition axes being distinct, it is possible to reconstruct without ambiguity the relief of the object's illuminated surface by means of a phase analysis technique. Accordingly, said relief is the almost-complete relief of the object's illuminated surface.

In the two-channel system, once the beam is generated by the source and scaled by the broadener to the dimensions required for illuminating the object's surface, the mask conforms the initial pattern of the light-fringe phase distribution. The processor determines which pixels of the mask have to be opaque or transparent to the beam light that passes therethrough. After transmission of the beam by the mask, the initial pattern is formed, preferably, in a parallel cross-section of the same beam (a non-divergent and non-convergent straight beam). In an alternative, the illumination beam can be divergent, but the process therefore becomes complicate because the divergence has to be known to be taken into account so as to correct the surface measurement calculations.

The beam illuminates the object's surface and is either reflected by the surface (surface opaque to the beam light, operation in reflection) or transmitted through the object (object transparent to the beam light, operation in transmission). In the latter case, it is to be noted that the transparent objects (it is nevertheless necessary that a fringe pattern is deposited on the object's surface and can be viewed thereon) can be measured in transmission, provided that one of the two passed-through faces between the illumination point(s) (PI) and the shooting point(s) (PV) does not deform the fringe pattern that has been formed on the other face, otherwise the information is no longer reliable because it is impossible to make the difference between the deformations of either face of the object.

The images formed on the object's surface and viewed according to the two viewing points of the two cameras are acquired and digitized by the two cameras, which transmit them to the processor.

Before performing the calculations, the processor acquires several images of the object's illuminated surfaces. Between each acquisition, the processor controls the mask so that the initial pattern of the light-fringe phase distribution is shifted in the space, i.e. the phase distribution is submitted to a desired and thus known phase-shifting.

The processor can thus perform the required calculations: it calculates the phase variations of the light-fringe phase distribution and then performs the analysis of this phase thanks to the two view points (i.e. it determines the absolute value and not the value modulo 2π), which allows to obtain the exact relief of the object's surface, i.e. without ambiguity. Further, the surface portions that can not be viewed by a channel can be viewed by the other, which allows the reconstruction of almost all the surface illuminated by the two illumination incidences.

An exemplary algorithm that can be used for such a two-channel system 1PI/2PV is shown in FIG. 2.

As an alternative, a two-channel system can comprise two illumination points and one camera. It is then denoted 2PI/1PV. An exemplary algorithm that can be used for such a two-channel system 2PI/1PV is shown in FIG. 3.

For a reconstruction of the almost-complete relief of almost the entire external surface of the object, the tetrahedral multi-channel system with four illumination points and four shooting points of the invention may be implemented. For example, the system comprises, on the one hand, for the device intended to illuminate the object with fringes, preferably:
a uniform light source, which is the most homogeneous possible,
a beam broadener,
a liquid crystal screen (the “mask”),
four-output optical beam switch,
several mirror for deflection toward the object (in alternative embodiments, the illumination system can have other arrangements, in particular regarding the number of sources, broadeners, screens and switches, the type of which are adapted accordingly),
and on the other hand, for the acquisition and processing part, preferably:
four cameras (in alternative embodiments, the number of cameras can be reduced),
a processor.

The mirrors are distributed between four systems of mirrors and arranged in the space so as to be capable of inflecting a light beam according to either one of four possible incidences, each incidence being defined by a system of mirrors that permits illumination of the object's surface according to a peculiar projection/illumination axis.

The optical beam switch is controlled by the computer and directs the light beam from the mask toward either one of the systems of mirrors. Thus, the object's surface is sequentially illuminated according to four possible projection/incidence axes of the tetrahedral multi-channel system of the invention.

A projection/incidence axis is defined by the segment from the centre of the last mirror of each possible path (said mirror reflecting directly the light fringes onto the object to illuminate the latter with fringes) to the centre of the illuminated surface. Each last mirror defines an illumination point. The four illumination points are placed at the vertices of a tetrahedron (or near these vertices), at the centre of which is located the object to be illuminated. The edges from the illumination points through the centre of the tetrahedron are merged with the projection axes of the system. The four illumination points are sufficiently remote from the object so that each couple of illumination points illuminates the surface delimited by the contour viewed according to the pseudo-normal of said surface, wherein the pseudo-normal is the median of the two projection axes in the plan defined by these latter.

Each of the four cameras (or a mirror for deflection toward a camera) is placed at a point located on one of the four medians (from the centre of the above-defined tetrahedron, with one camera by median) of the four trihedrons formed by the four triplets of projection axes, or placed near one of these four medians. Therefore, each camera is placed at a shooting point. The edges from the shooting points through the centre of the tetrahedron define the shooting axes of the system.

The four shooting points are sufficiently remote from the object so that the field of view of each couple of shooting points includes the surface defined as above by the couple of the two adjacent projection axes common to the two shooting axes of the couple of shooting points.

This arrangement is schematically shown in FIG. 4, in which an object is placed at the centre O of a tetrahedron, the four vertices PI1, PI2, PI3 and PI4 of which form the four illumination points. The fringe-carrier light-beams start from these four illumination points, along the projection/illumination axes PI1-O, PI2-O, PI3-O and PI4-O, and are directed toward the centre of the tetrahedron, so that they illuminate the object with fringes. The four illumination axes allow to define four trihedrons formed by triplets of projection axes (there are four triplets). The median of each trihedron is the support of one shooting axis, so that four shooting axes are defined, PV1,2, PV2,3, PV3,4 and PV1,4.

The processor performs the reconstruction of the distinct partial reliefs defined by each couple of projection and shooting axes, and then, based on these reliefs, the reconstruction without ambiguity of the almost-complete relief of the different illuminated surfaces of the object. Thanks to the reconstruction without ambiguity and almost complete of these illuminated surfaces, the processor performs the reconstruction without ambiguity of the almost-complete relief of the entire external surface of the illuminated object.

The four projection axes allow to project fringes onto the object but not necessarily the same set of light fringes for all the axes. A set of images of each of the six surfaces illuminated and defined by the six couples of illumination points are acquired. These images allow to recover the partial reliefs (viewed according to two couples of projection and acquisition axes defined by two projection axes and one acquisition axis, or by one projection axis and two acquisition axes, or else by one projection axis and one shooting axis and another projection axis and another shooting axis, all of them being adjacent to each other) of each of the six illuminated surfaces of the object. These partial reliefs allow to recover without ambiguity almost all the details of the relief, i.e. the almost-complete relief, of each of the six illuminated surfaces of the object. The almost-complete reliefs thus recovered without ambiguity of the six possibilities of illuminated surfaces of the object allow to also recover without ambiguity almost all the details of the entire external surface of the object.

It to be noted that the term “almost” (almost-complete) is used to take into account cases, that are generally exceptional, in which some small portions of the object would not receive any illumination or would be invisible because of a surface obstacle such as, for example, a fold, a deep groove inclined relative to the illumination or shooting axis, etc., the invention allowing, when complete illumination and viewing of the surface are possible, to recover all the surface details.

It can also be noted that the light fringes implemented are “analog” in the sense that the transition between the luminosity minimum and the luminosity maximum is continuous, i.e. is a grey-level shading, and not a steep transition, which would then be referred to as “digital”. So as to obtain such “analog” fringes, a grey-level-controllable mask/liquid crystal screen is implemented. This allows to improve the accuracy of relief reconstruction of the object's illuminated surface. It can also be noted that the pitch of the light fringes determines the accuracy/resolution of the relief measurement. The smaller is the pitch, the best the measurement accuracy of the PSM method can be. However, this accuracy is also determined by the quality of the other components of the system, such as, for example, the grey-level pitch that can be distinguished by the acquisition camera and the resolution of the acquisition camera, namely its pixel periodicity pitch. Finally, the quality of the image processing algorithm also determines both the measurement resolution and accuracy of the PSM method.

Examples of implementation of the invention will now be more concretely described.

Firstly, let's consider a substantially spherical object, the surface of which is uneven (complex relief) and is illuminated by the tetrahedral multi-channel system. Its surface is fully recovered. To allow the illumination (and visualisation) of the object at the centre of the tetrahedron from underneath, the object can be placed on a transparent support (for example, a transparent plate which can not be illuminated/retain the illumination and which let through the fringe pattern without deforming it or with a deformation that can be taken into account) or it can be maintained up in the air by one or more threads or ribbons or, in a more complex alternative, it can be driven in a controlled-rotation by the processor to be fringe-lighted and observed from all its faces. To obtain the required level of accuracy in this example, it is necessary to have five shifted-fringe systems per illuminated surface. The shooting succession is then as follows (with reference to FIG. 5):
PI1 uses the fringe system F1 for illumination, and PV123, PV124, PV134 acquire simultaneously three images of projected fringes {IM_{F1 123 i}; IM_{F1 124 i}; IM_{F1 134 i}}_{i=1, . . . , 3}; the partial reliefs R123, R124 and R134 of the illuminated surface are recovered through the two-channel algorithm 1PI/2PV described above for each triplet one illumination point/two shooting points contained in the quadruplet (PI1, PV123, PV124, PV134).
PI2 uses the fringe system F2 for illumination, and PV123, PV124, PV234 acquire simultaneously three images of projected fringes {IM_{F2 123 i}; IM_{F2 124 i}; IM_{F2 234 i}}_{i=1, . . . , 3}; the partial reliefs R123, R124 and R234 of the illuminated surface are recovered through the two-channel algorithm 1PI/2PV described above for each triplet one illumination point/two shooting points contained in the quadruplet (PI2, PV123, PV124, PV234).
PI3 uses the fringe system F3 for illumination, and PV123, PV134, PV234 acquire simultaneously three images of projected fringes {IM_{F3 123 i}; IM_{F3 134 i}; IM_{F3 234 i}}_{i=1, . . . , 3}; the partial reliefs R123, R134 and R234 of the illuminated surface are recovered through the two-channel algorithm 1PI/2PV described above for each triplet one illumination point/two shooting points contained in the quadruplet (PI3, PV123, PV134, PV234).
PI4 uses the fringe system F4 for illumination, and PV124, PV134, PV234 acquire simultaneously three images of projected fringes {IM_{F4 124 i}; IM_{F4 134 i}; IM_{F4 234 i}}_{i=1, . . . , 3}; the partial reliefs R124, R134 and R234 of the illuminated surface are recovered through the two-channel algorithm 1PI/2PV described above for each triplet one illumination point/two shooting points contained in the quadruplet (PI4, PV124, PV134, PV234).

Each triplet of partial reliefs allows to recover almost all the surface of an hemisphere of the sphere, each hemisphere being illuminated by one illumination point because this point is sufficiently remote from the sphere for that purpose. There are four hemisphere surfaces, oriented at 120° relative to one another. They allow the surface of the sphere to be almost fully and completely covered.

This example of a spherical object corresponds to an implementation that is more generally intended to the processing of an object whose surface relief is not known a priori. It is a relatively heavy implementation that requires a complex phasing.

Now, let's consider an object in the form of a smooth plate. In this example of implementation, only the reliefs of its upper surface and its lower surface are subjected to processing. This plate is perpendicular to the projection axis from the illumination point PI1. This implementation, which is simpler than the previous one, requires only three shifted-fringe systems per illuminated surface. The shooting succession is then as follows:
PI1 uses the fringe system F1 for illumination, and PV123, PV134 acquire simultaneously three images of projected fringes {IM_{F1 123 i}; IM_{F1 134 i}}_{i=1, . . . , 3}; the complete relief (the surface is smooth, without any asperity or shade area) of the upper surface of the plate is recovered through the two-channel algorithm 1PI/2PV.
PI2 uses the fringe system F2 for illumination, and PV234 acquires three images of projected fringes {IM_{F2 234 i}}_{i=1, . . . , 3}; and
PI3 uses the fringe system F3 for illumination, and PV234 acquires three images of projected fringes {IM_{F3 234 i}}_{i=1, . . . , 3}; based on the set of images {IM_{F2 234 i}; IM_{F3 234 i}}_{i=1, . . . , 3}, the complete relief of the lower surface of the plate is recovered through the two-channel algorithm 2PI/1PV.

This example, having a rather simple phasing, is implemented when the application processes an object whose surface relief is known a priori (identification of an expected object or measurement of the relief conformity with respect to a given model).

Now, let's consider an object in the form of a smooth plate comprising a relief on one of the faces thereof. In this example of implementation, only the reliefs of its upper surface and its lower surface are subjected to processing. This plate is perpendicular to the projection axis from the illumination point PI1. The upper surface carries a little promontory (a parallelepiped). This implementation is again rather simple and requires only three shifted-fringe systems per illuminated surface. The shooting succession is then as follows:
PI1 uses the fringe system F1 for illumination, and PV123, PV124, PV134 acquire simultaneously three images of projected fringes {IM_{F1 123 i}; IM_{F1 124 i}; IM_{F1 134 i}}_{i=1, . . . , 3}; the partial reliefs R123, R124 and R134 of the illuminated surface are recovered through the two-channel algorithm 1PI/2PV described above for each triplet one illumination point/two shooting points contained in the quadruplet (PI1, PV123, PV124, PV134); then, the complete relief of the upper surface of the plate is recovered based on the three partial reliefs.
PI2 uses the fringe system F2 for illumination, and PV234 acquires three images of projected fringes {IM_{F2 234 i}}_{i=1, . . . , 3}; and
PI3 uses the fringe system F3 for illumination, and PV234 acquires three images of projected fringes {IM_{F3 234 i}}_{i=1, . . . , 3}; based on the set of images {IM_{F2 234 i}; IM_{F3 234 i}}_{i=1, . . . , 3}, the complete relief of the lower surface of the plate is recovered through the two-channel algorithm 2PI/1PV.

This example, having a rather simple phasing, has needed an additional acquisition with respect to the previous example, because of the partially blind areas (i.e. blind for only one duet: illumination point/shooting point) due to the promontory for each triplet 1PI/2PV which processes the upper surface. Therefore, it can be seen that, in the tetrahedral multi-channel system of the invention, no adjustment equipment is necessary (no displacement of the illumination/shooting points or of the object). Only one changing has been required in the image processing. The tetrahedral multi-channel system of the invention is thus flexible and complete.

It is to be noticed that if the illumination points are placed sufficiently remote from the processed object, each illumination axis illuminates a defined extent of the processed object's surface, such extent generally overlaps a portion of the extent illuminated by each of the three other illumination axes, except in case of exceptionally unfavorable geometry of the processed object. Such overlapping is understandably desirable so that no extent of processed object's surface is let non illuminated and thus not processed.

It is also preferable not to let several channels illuminate simultaneously a same surface of the processed object so as not to deteriorate the information carried by the fringed images of each illumination channel. Nevertheless, it is possible to multiplex these different images by the color of illumination of the fringes, as will be explained hereinafter.

Some examples of physical configurations of the tetrahedral multi-channel system of the invention will now be described.

A first configuration, referred to as the “trivial” configuration, comprises four light sources, four beam broadeners, four liquid crystal screens and four cameras. In this “trivial” configuration, the measurement accuracy is the best one because the projection of patterns and the acquisition performed by the cameras are direct and thus without deformation of the fringed image through intermediate components. However, the cost of this physical configuration is relatively high.

A second configuration, referred to as the “economical” configuration, comprises one light source, one beam broadener, one liquid crystal screen placed immediately after the beam broadener, one camera, three one-input/two-output (1×2) optical switches and three two-input/one-output (2×1) optical switches. The three 1×2-switches are intended to switch the light emitted by the source toward one of the four paths each leading to one of the four illumination points by placing one 1×2-switch at each output of the 1×2-switch, the input of which picks-up the light emitted by the source, the outputs of the two downstream switches each feeding one of the paths leading to one of the four illumination points. The three 2×1-switches are intended to switch the light emerging from each shooting point toward the camera by placing one 2×1-switch so that the latter picks-up the light emerging from two paths coming from two shooting points and one 2×1-switch so that the latter picks-up the light emerging from two other paths coming from the two other shooting points and by placing the third 2×1-switch so that the latter picks-up the light emerging from the outputs of the two previous 2×1-switches and that the output thereof illuminates the camera. Finally, a set of mirrors (preferably, “almost-perfect” mirrors) supplements the configuration to orientate the four paths carrying the light to the four illumination points and the four paths coming from the four shooting points.

In an alternative to this second configuration, instead of the above-mentioned 1×2 and 2×1 switches, the switches that are used are a one-input/four-output (1×4) switch and a four-input/one-output (4×1) switch. The 1×4-switch switches the light emitted by the source toward one of the four paths each leading to one of the four illumination points, and the 4×1-switch switches toward the camera the light emitted by each of the four paths each coming from the four shooting points. As above, a set of mirrors supplements this configuration so as to orientate the four paths carrying the light to the four illumination points and the four paths coming from the four shooting points.

Such second configurations provide a measurement accuracy slightly lower than that of the first configuration because of the small image deformations introduced by imperfection of the mirrors and that is the reason why “almost-perfect” mirrors are preferably used. It can be noted that a calibration step with one benchmark object can allow for those imperfections (and/or other ones) to be taken into account and for corrections to be made during measurements of objects to be measured. On the other hand, the cost of these second physical configurations is lower than that the first one.

A third physical configuration is derived from the second configurations and comprises the same elements, except that there are four liquid crystal screens instead of only one, each screen being placed between one of the four illumination points and the processed object. The measurement accuracy is better than that of the second configurations because of the absence of deformation of the projected patterns, such absence being due to the elimination of the intermediate components between the liquid crystal screens and the surface of the processed object. The cost of this third physical configuration is low but a little higher than the cost of the second configurations.

A fourth physical configuration is derived from the second configurations and allows to obtain a compromise between cost and accuracy. This fourth configuration comprises the same elements than those of the second configurations but with four cameras each placed at one of the four shooting points and only three 1×2 switches or one 1×4 switch which switch the light emitted by the source toward one of the four paths leading to the four illumination points at the same time. Accordingly, the obtained measurement accuracy is better than that of the second and third configurations because the acquisition by the cameras is direct and thus without deformation of the fringed image through intermediate components. However, the cost is a little higher than those of the second and third configurations bus lower than that of the first configuration.

A fifth physical configuration is derived from the fourth configuration and also allows to obtain a compromise between cost and accuracy. This fifth configuration comprises the same elements than those of the fourth configuration but with four liquid crystal screens each placed between one of the four illumination points and the surface of the processed object. Accordingly, the obtained measurement accuracy is better than that of the fourth configuration because the projection of patterns and the acquisition performed by the cameras are direct and thus without deformation of the fringed image through intermediate components. However, the cost is a little higher than that of the fourth configuration bus lower than that of the first configuration.

The control modes for implementation of the invention will now be more fully described.

There are three possible control modes for the tetrahedral multi-channel system of the invention. Each control mode comprises different illumination/acquisition phases, some examples of which are given hereinafter.

A first mode is a full-control mode wherein all the quadruplets defined by one illumination point and three shooting points operate, and this, one after the other (one illumination and three sets of acquisition). Thus, for each projection axis, three sets of acquired images are available for the processing, one set per shooting axis. The obtained information is the most complete possible but the acquisition time is the least optimized and the use of the computer resources is the heavier. However, because the three shooting points operate simultaneously, the acquisition time per quadruplet is the same as for a single-channel system (one illumination point, one shooting point) but, on the other hand, the processing time is longer because there is more information to process.

It is to be noted that, in an alternative, the quadruplets can be defined by one shooting point and three adjacent illumination points. Thus, for each shooting point, three sets of acquired images are available for the processing, one set per projection axis. However, unlike the previous example of quadruplets wherein three shooting points can acquire their images simultaneously, the quadruplets three illumination points/one shooting point constrains the shooting point to acquire all the images in a sequential manner, because each illumination point illuminates one after the other so as not to destruct the fringe patterns projected by each of the different illumination points. However, this last control mode is of little interest, notably regarding the acquisition time which is the longest for the tetrahedral multi-channel system of the invention (except in case of colorimetric multiplexing).

A second mode is a half-control mode. It corresponds to the previous one, except that some or all of the quadruplets are reduced to triplets (one illumination point and only two adjacent shooting points) and that only the quadruplets or triplets that are necessary for the recovering of the almost-complete relief of the entire surface of the processed object operate, so as to avoid any useless redundant information. The acquisition time and the use of computer resources are improved. The degrees of complexity of the surface relief and of the geometry of the processed object determine the number of quadruplets and/or triplets necessary for the required processing.

A third mode is an optimized-control mode, wherein an illumination channel and a camera with an adjacent shooting axis operate at the same time, the different couples or duets illumination point/shooting point operating one after the other. The duets illumination point/shooting point are chosen so that the information necessary for processing the processed-object surface is sufficient to recover the almost-complete relief of this entire surface but is also reduced to the minimum necessary for that purpose. However, if two duets have an illumination point in common and if that is necessary for the correct recovering of the almost-complete relief of the illuminated surface, it is clear that these two duets have to operate simultaneously, i.e. to form a new triplet. Likewise, for three duets with an illumination point in common, they gather together into a quadruplet. Thus, the acquisition time is optimized as well as the use of the computer resources. This control mode can be implemented only if the relief and geometry of the processed object are sufficiently simple.

It is understood that the invention can be adapted in many ways without thereby departing from the scope thereof as defined by the appended claims.

Accordingly, although the FP-PSM method is the best adapted to the tetrahedral multi-channel system of the invention, other methods can be implemented with such a system for solving the complete (or almost-complete) relief of the entire external surface of a three-dimensional object. Likewise, regarding the system structure, the number of light sources, broadeners and liquid crystal screens for the generation of fringes can be comprised between one (as described above) and four, the fringe-illumination-beam switching system(s) and mirrors for deflection toward the object being provided accordingly. It may be the same for the number of cameras, comprised between one and four, and, in case of less than four cameras, means (switchable mirror(s), displacement of camera(s) . . . ) for performing shootings from the four locations are provided to allow the described geometrical distribution. Moreover, in alternative embodiments, the illumination-beam switching system(s) can be combined with the mirrors, wherein the mirror acts as a beam-switching means. Finally, many applications are possible downstream the measurement: simple 3D-visualisation on a 2D-display, space-visualisation by means of 3D-visualisation means, control of a 3D-object photo-polymerization machine or of a machining centre . . . .

Moreover, if, preferably, the light fringes are black and white with intermediate grey levels (analog fringes), the invention may be applied to color fringes, several illumination devices, each having a specific color, being implemented for a colorimetric multiplexing, the color camera(s) and the computer equipment being capable of making the difference between the illumination fringes according to the color during simultaneous illuminations of the object from several illumination points. The measurements may also be repeated with different fringe arrangements and structures (orientation and/or frequency of the pattern and/or different frequency according to the position on the object's surface . . . after an iterative adaptation process for obtaining an improvement of the accuracy, notably in particular surface areas of the object), notably for improving the quality of the results. Finally, one or more calibration steps with benchmark objects can allow various optical aberrations and/or slight offsets in the arrangement of the elements of the system to be taken into account during the next measurements on the objects to be measured.

1. Optical computerized method for the 3D measurement of the external surface of an object in relief by projection of fringes onto said object and use of a phase-shifting method, the fringes being projected onto the object by means of at least one illumination device, images of the fringed object being taken according to several shooting axes by means of at least one shooting means, said images being transmitted to a computer equipment comprising a program for the calculation of relief based on the images,
characterized in that four projection axes of the fringes onto the object are implemented, the origin of each projection axis being considered as an illumination point located substantially at each of the four vertices of a virtual tetrahedron, the object being placed substantially at the centre of said tetrahedron, and in that the shootings are taken from four shooting points located substantially along four shooting axes, each of the shooting axes being the median of one of the four trihedrons formed by the four triplets of projection axes, the four shooting points being located at such a distance from the object that, at each shooting point, each image includes at least one portion of each of the three surfaces of the object that can be lighted by the three illumination points of the triplet of projection axes, the median of which defines the shooting axis of said shooting point, and in that a set of images of each of the six surfaces that can be illuminated and defined by six couples of illumination points is acquired into the computer equipment.

2. Method according to claim 1, characterized in that the four illumination points come from at least one to four fringe-illumination devices, and in that said device(s) is(are) located at the illumination points and/or the illumination(s) of said means are redirected by at least one mirror and/or said means is(are) physically movable.

3. Method according to claim 2, characterized in that the four illumination points come from only one illumination device, and in that the illumination from said means is redirected along the corresponding projection axis by a set of mirrors.

4. Method according to claim 2, characterized in that the mirror(s) is(are) controlled by the computer equipment.

5. Method according to claim 1 characterized in that each illumination device is provided with a light source, a beam broadener and a liquid crystal screen controlled by the computer equipment to form therein a fringe pattern.

6. Method according to claim 1 characterized in that analog light fringes are implemented.

7. Method according to claim 1 characterized in that four independent fixed shooting means are implemented, which are located at the shooting points.

8. Method according to claim 1 characterized in that, for the shootings, the object is sequentially illuminated according to the four projection axes, to acquire a set of images of each of the six surfaces that can be illuminated and defined by six couples of illumination point.

9. System for the 3D measurement of the external surface of an object, intended for implementing the method according to claim 1, characterized in that it comprises at least one device for illuminating the object with fringes and a part for image acquisition and calculation of relief, in a computer equipment comprising a program, based on said images acquired by at least one shooting means, the illumination device(s) allowing fringes to be projected onto the object according to four projection axes, the origin of each projection axis being considered as an illumination point located substantially at each of the four vertices of a virtual tetrahedron, the object being placed substantially at the centre of said tetrahedron, and the shootings are taken from four shooting points located substantially along four shooting axes, each of the shooting axes being the median of one of the four trihedrons formed by the four triplets of projection axes, the four shooting points being located at such a distance from the object that, at each shooting point, each image includes at least one portion of each of the three surfaces of the object that can be lighted by the three illumination points of the triplet of projection axes, the median of which defines the shooting axis of said shooting point, and in that the computer equipment comprises means for acquiring a set of images of each of the six surfaces that can be illuminated and defined by six couples of illumination points.

10. Measurement system according to claim 9, characterized in that the illumination device comprises a light source, a beam broadener and a liquid crystal screen controlled by the computer equipment to form therein a fringe pattern.

11. Method according to claim 3, characterized in that the mirror(s) is(are) controlled by the computer equipment.

12. Method according to claim 2, characterized in that each illumination device is provided with a light source, a beam broadener and a liquid crystal screen controlled by the computer equipment to form therein a fringe pattern.

13. Method according to claim 2, characterized in that analog light fringes are implemented.

14. Method according to claim 2, characterized in that four independent fixed shooting means are implemented, which are located at the shooting points.

15. Method according to claim 2, characterized in that, for the shootings, the object is sequentially illuminated according to the four projection axes, to acquire a set of images of each of the six surfaces that can be illuminated and defined by six couples of illumination point.

16. Method according to claim 3, characterized in that each illumination device is provided with a light source, a beam broadener and a liquid crystal screen controlled by the computer equipment to form therein a fringe pattern.

17. Method according to claim 3, characterized in that analog light fringes are implemented.

18. Method according to claim 3, characterized in that four independent fixed shooting means are implemented, which are located at the shooting points.

19. Method according to claim 3, characterized in that, for the shootings, the object is sequentially illuminated according to the four projection axes, to acquire a set of images of each of the six surfaces that can be illuminated and defined by six couples of illumination point.
